(19) United States
(12) Patent Application Publication
(10) Pub. No.: US 2020/0097603 A1
(43) Pub. Date: Mar. 26, 2020

(54) USING VIDEO OF NAVIGATION THROUGH A USER INTERFACE AS CONTEXT IN TRANSLATING THE USER INTERFACE

(71) Applicant: CA, Inc., New York, NY (US)

(72) Inventors: Narsimha Ravi Teja Vangala, Hyderabad (IN); Guru Prasadareddy Narapu Reddy, Hyderabad (IN); Srikanth Suragala, Hyderabad (IN); Sreenivasulu Bandi, k.v.Rangareddy (IN); Nivedita Aggarwal, Hyderabad (IN)

(73) Assignee: CA, Inc., New York, NY (US)

(21) Appl. No.: 16/139,862

(22) Filed: Sep. 24, 2018

(51) Int. Cl. G06F 17/30; H04N 21/472

(52) U.S. Cl. CPC G06F 17/30796; H04N 21/472; G06F 17/30817; G06F 17/30852

(57) ABSTRACT

A processing device obtains a video of navigation through a user interface of an application. The video is divided into a plurality of frames that are based on time units. Each frame of the plurality of frames including a plurality of strings comprising text. A string of the plurality of strings that is in a first frame is determined. A time value that is associated with the first frame is determined. A location of the string that is in the first frame is determined. An untranslated resource bundle is generated and includes a mapping of the string of the plurality of strings to the time value of the first frame of the plurality of frames and to the location of the string of the plurality of strings. The video and the untranslated resource bundle are transmitted to a remote device via a communication interface communicatively coupled to the processing device.

### TECHNICAL FIELD

The present disclosure relates to computing systems, and, in particular, to a computer system for using video of navigation through a user interface as context in translating the user interface.

### BACKGROUND

A user interface (“UI”) for an application can include various pages, menus, and windows with various strings of text. Some applications include different versions of UIs that each include strings of text in different languages. Translating the strings in a UI without proper context can result in ambiguities and poor translations. For example, the word “run” can have different meanings: in the phrase “I run this business” and “I run marathons” the meaning of the word “run” changes based on the context. Another language may have different words that each correspond to a different meaning of “run.” Thus, to accurately translate strings in a UI, context for the word may be needed.

Developers of UIs may provide a screenshot of a string in a UI as a reference when requesting a translation. But, manually taking a screenshot for each translatable string in a UI can be resource intensive and time consuming. Furthermore, a screenshot may not provide sufficient context for a translator to understand the circumstantial events which cause the string to be displayed in the UI. For example, a screenshot of a string that states, “thanks for submitting the data,” may not provide sufficient context for the word “data” to be properly translated. The screenshot may not indicate whether the “data” is personal data, machine details data, or demographic data. Therefore, sharing screenshots as references when requesting a translation of a string does not eliminate ambiguity and ensure an accurate translation.

### SUMMARY

Some embodiments disclosed herein are directed to a method of performing operations on a processing device for preparing a video of navigation through a user interface of an application as context in translating the user interface. The method includes obtaining a video of navigation through a user interface of an application. The video of the navigation through the user interface of the application is divided into a plurality of frames that are based on time units. Each frame of the plurality of frames includes a plurality of strings comprising text. The method further includes determining a string of the plurality of strings that is in a first frame of the plurality of frames. The method further includes determining a time value that is associated with the first frame of the plurality of frames. The method further includes determining a location of the string of the plurality of strings that is in the first frame of the plurality of frames. The method further includes generating an untranslated resource bundle that includes a mapping of the string of the plurality of strings to the time value of the first frame of the plurality of frames and to the location of the string of the plurality of strings. The video of navigation through the user interface of the application and the untranslated resource bundle are transmitted via a communication interface to a remote device.

Other embodiments disclosed herein are directed to a method of performing operations on a processing device for using a video of navigation through a user interface of an application as context in translating the user interface. The method includes a processing device receiving, via a communication interface, the video of navigation through the user interface of the application. The video of navigation through the user interface of the application can include a plurality of frames. The processing device can further receive an untranslated resource bundle associated with the video. The untranslated resource bundle can include a mapping of a string in the video to a first frame of the plurality of frames and a location of the string within the first frame. The processing device can further detect a selection of the string in the untranslated resource bundle. Responsive to detecting the selection of the string, the processing device can determine a second frame of the plurality of frames that is non-duplicative of the first frame and occurs before the first frame in the video. The video can be displayed starting at the second frame until the first frame. Responsive to displaying the video, the processing device can receive a translated version of the string. A translated resource bundle can be generated based on the translated version of the string and the untranslated resource bundle.

Corresponding operations by computer program products and electronic devices are disclosed. Other methods, computer program products, and electronic devices according to embodiments will be or become apparent to one with skill in the art upon review of the following drawings and detailed description. It is intended that all such additional methods, computer program products, and electronic devices be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Aspects of the present disclosure are illustrated by way of example and are not limited by the accompanying drawings. In the drawings:

FIG. 1 is a block diagram of an example of a system for using video of navigation through a user interface as context in translating the user interface in accordance with some embodiments of the present disclosure;

FIG. 2 is a block diagram of an example of a preparing device for preparing the video of navigation through the user interface for use as context in translating the user interface in accordance with some embodiments of the present disclosure;

FIG. 3 is a block diagram of an example of a translating device for determining a translation of the user interface using the video of navigation through the user interface in accordance with some embodiments of the present disclosure;

FIG. 4 is a flow chart of an example of a process for preparing a video of navigation through a user interface for use as context in translating the user interface in accordance with some embodiments of the present disclosure;

FIG. 5 is a flow chart of an example of a process for modifying a version of the user interface in response to receiving a translation associated with the video in accordance with some embodiments of the present disclosure;

FIG. 6 is a flow chart of an example of a process for determining a translation of strings in a user interface using a video of navigation through the user interface in accordance with some embodiments of the present disclosure;

FIG. 7 is a block diagram of another example of a system for using video of navigation through a user interface as context in translating the user interface in accordance with some embodiments of the present disclosure; and

FIG. 8 is a block diagram of an example of a video of navigation through a user interface divided into frames and usable as context in translating the user interface in accordance with some embodiments of the present disclosure.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components, and circuits have not been described in detail so as not to obscure the present invention. It is intended that all embodiments disclosed herein can be implemented separately or combined in any way and/or combination.

As explained above, a user interface (“UI”) of an application can include strings of text that are selected for translation in order to generate a translated version of the UI, but obtaining high quality translations of the strings can be difficult due to a lack of context provided to translators. Manually taking screenshots of the UI for each string desired to be translated can be time consuming, resource intensive, and still fail to provide sufficient context for an accurate translation.

Various embodiments of the present disclosure are directed to providing more complete and circumstantial context for translatable strings in a UI by using a video of navigation through the UI. In some embodiments, a video of navigation through a UI of an application is provided. The video can be divided into a set of frames at different time values and each frame can include translatable strings of text. An untranslated resource bundle can be generated that maps each of the translatable strings to a location within a frame of the video. The video and the untranslated resource bundle can be transmitted to a remote device associated with the translator. The video can be displayed to a translator to provide context for the translatable strings. A translated resource bundle can be generated that maps each translated version of the strings to the translatable strings or to the location within the frame of the video. A translated version of the UI can be generated by modifying the UI using the translated resource bundle.

In some embodiments, a video of navigation through the UI is automatically captured. For example, a video recorder can detect a change to the UI and, in response, can automatically capture a video of navigation through the UI. Automatically capturing a video of navigation through the UI can be performed as part of other development systems and may eliminate capturing screenshots for each translatable string. Using a video of navigation through the UI can significantly reduce the effort and time required by developers to provide contextual information to translators, which can reduce the time required to generate a translated version of a UI.

In some embodiments, the untranslated resource bundle can be packaged with the video such that a specific portion of the video is played in response to selection of a translatable string. For example, in response to a translator selecting a translatable string for translation from the untranslated resource bundle, the video can begin at a predetermined frame that displays user interaction with the UI that is associated with the selectable translatable string and the video can end at a frame that displays the selected translatable string. Playing a portion of the video before the frame with the translatable string can provide the translator with circumstantial context for the string, which can improve the quality of the translation. In one example, a translatable string may include a confirmation message, “Thanks for submitting the data.” In response to selection of the translatable string, the video may begin from a frame of the video that includes a form requesting contact data and a submit button that when selected by a user of the UI generates the confirmation message and the video may end at a frame displaying the confirmation message. The video in this example can provide a translator with context indicating the type of data that has been submitted.

In additional or alternative embodiments, the untranslated resource bundle may be packaged with the video such that a visual effect may be displayed at the location of a selected translatable string. For example, the translatable string may be highlighted, bolded, circled, or the color of the text may be modified to help flag the string within the frame of the video.

In additional or alternative embodiments, the untranslated resource bundle may be packaged with the video to provide additional seek functionality. For example, if a translatable string is present in multiple frames of the video, the video may include selectable links for jumping between different frames associated with the translatable string. The translator can also pause and replay any portion of the video to gain additional context.

Some embodiments of the present disclosure can provide various improvements to the field of translating UI of applications and can be applicable to all applications (e.g., desktop applications, console applications, mobile applications, and web-based applications). Providing a video of navigation through the UI of an application can result in higher quality translations of the UI. For example, the translation quality can improve in response to the translator obtaining a circumstantial context from the video of navigation through the UI. Moreover, translators can understand the context of a translatable string in an efficient way by watching the contextual video for the translatable string with the help of auto seek functionality.

Furthermore, some embodiments of the present disclosure allow for faster generation of translated versions of UIs. For example, the video of navigation through the UI can be automatically captured and packaged with an untranslated resource bundle, and a single video file can be transmitted per translation request. A translated resource bundle can be received and automatically used to generate a translated version of the user interface. Additionally, in some embodiments, the processing resources and transmission bandwidth can be reduced by automatically reducing the frame rate or resolution for part of the video based on detecting duplicate frames.

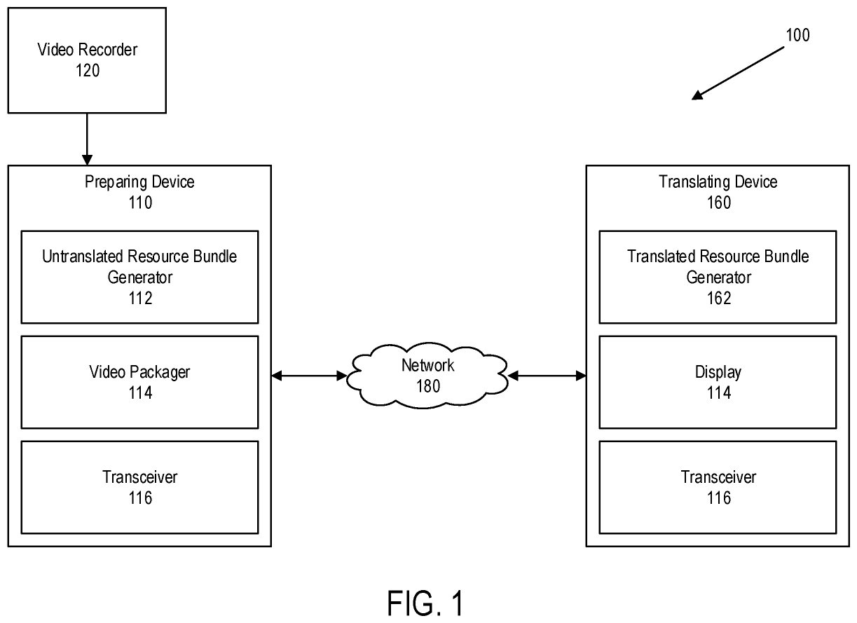

FIG. 1 is a block diagram of an example of a system 100 for using video of navigation through a UI of an application as context in translating the UI in accordance with some embodiments of the present disclosure. System 100 includes a preparing device 110, a video recorder 120, and a translating device 160.

The preparing device 110 is communicatively coupled to the video recorder 120 for receiving a video from the video recorder 120. In some embodiments, the video recorder 120 can capture a video of navigation through a UI of an application. The application can be for any environment such as desktop, console, mobile, or web environment. The UI can be under development and the video recorder 120 can automatically capture navigation through the UI, for example, in response to detecting changes to the UI. In some embodiments, the video recorder 120 can provide the raw video to the preparing device 110. In additional or alternative embodiments, the video recorder 120 can edit the video, for example, by dividing the video into a series of frames based on a time value. The video recorder 120 can also remove duplicate frames, reducing a resolution of duplicate frames, or lower a frame rate during consecutive duplicate frames. In additional or alternative embodiments, the preparing device 110 can perform these edits to the video.

The preparing device 110 can include an untranslated resource bundle generator 112, video packager 114, and a transceiver 116. The preparing device 110 can receive the video via the transceiver 116 and prepare an untranslated resource bundle associated with the video via the untranslated resource bundle generator 112. The untranslated resource bundle generator 112 can generate an untranslated resource bundle that includes a mapping of strings of text that are within the UI to locations of the strings within frames of the video. The strings can be considered translatable strings that have been selected to be translated into another language as part of a translated version of the UI. The video packager 114 can package the video and the untranslated resource bundle together and the transceiver 116 can transmit the package to the translating device 160 via a network 180.

The translating device 160 can include a translated resource bundle generator 162, a display 114, and a transceiver 116. The transceiver 116 can receive the package including the video and the untranslated resource bundle from the preparing device 110 and use them to determine a translated resource bundle. In some examples, the display 114 displays a portion of the video based on selection of a translatable string from the untranslated resource bundle by a translator or another user. The portion of the video can be determined by the translating device 160 or can be previously determined by the preparing device 110 and included in the untranslated resource bundle. The portion of the video can provide circumstantial context for the selected translatable string, and the translating device 160 can receive a translated version of the selected translatable string as input from the translator. The translated resource bundle generator 162 can use the translated version of the string and the untranslated resource bundle to generate the translated resource bundle. The translated resource bundle can map the translated version of the string to the associated translatable string or the location of the translatable string within the video.

The transceiver 116 can transmit the translated resource bundle back to the preparing device 110 via the network 180. The network 180 can be any communications network, for example, a telecommunications network. The preparing device 110 can generate the translated version of the UI by modifying the UI based on the translated resource bundle.

In some embodiments, the system 100 can be automated such that the only input is the UI to the video recorder 120 and the human translations to the translating device 160. In additional or alternative embodiments, the system 100 can detect changes in the UI and generate an untranslated resource bundle for only the altered or new translatable strings in the UI. The system 100 can then update an existing translated UI based on a new translated resource bundle to reflect the changes in the UI.

Although FIG. 1 depicts the system 100 as having the video recorder 120 as separate from the preparing device 110, in some embodiments the preparing device 110 includes the video recorder 120. In additional or alternative embodiments, the preparing device 110 can include more than one separate processing device that each perform a different portion of the preparation of the video, preparation of the untranslated resource bundle, and modification of the UI based on the translated resource bundle.

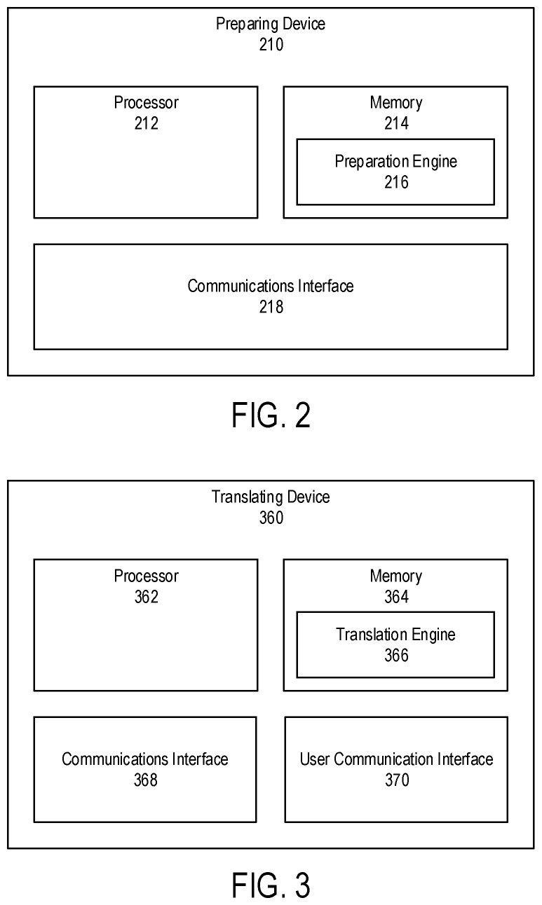

FIG. 2 is a block diagram of a preparing device 210, which is an example of the preparing device 110 in FIG. 1. In this example, preparing device 210 includes a processor 212, memory 214, and a communication interface 218. The processor 212 may include one or more data processing circuits, such as a general purpose and/or special purpose processor (e.g., microprocessor and/or digital signal processor) that may be collocated within the preparing device 210 or distributed across one or more networks. The processor 212 is configured to execute computer program code, for example preparation engine 216, in the memory 214, described below as non-transitory computer readable medium, to perform at least some of the operations described herein as being performed by the preparing device 210 or any component thereof. The communication interface 218 may be a wired network interface transceiver, e.g., Ethernet, and/or a wireless radio frequency transceiver that is configured to operate according to one or more communication protocols, e.g., WiFi, Bluetooth, cellular, LTE, etc.

FIG. 3 is a block diagram of a translating device 360, which is an example of the translating device 160 in FIG. 1. In this example, the translating device 360 includes a processor 362, memory 364, communications interface 368, and user communication interface 370. The processor 362 may include one or more data processing circuits, such as a general purpose and/or special purpose processor (e.g., microprocessor and/or digital signal processor) that may be collocated within the translating device 360 or distributed across one or more networks. The processor 362 is configured to execute computer program code, for example translation engine 366, in the memory 364, described below as non-transitory computer readable medium, to perform at least some of the operations described herein as being performed by the translating device 360 or any component thereof. The communication interface 368 may be a wired network interface transceiver, e.g., Ethernet, and/or a wireless radio frequency transceiver that is configured to operate according to one or more communication protocols, e.g., WiFi, Bluetooth, cellular, LTE, etc. The user communication interface 370 may be a display device, a touch input interface on a display device, a keyboard, etc.

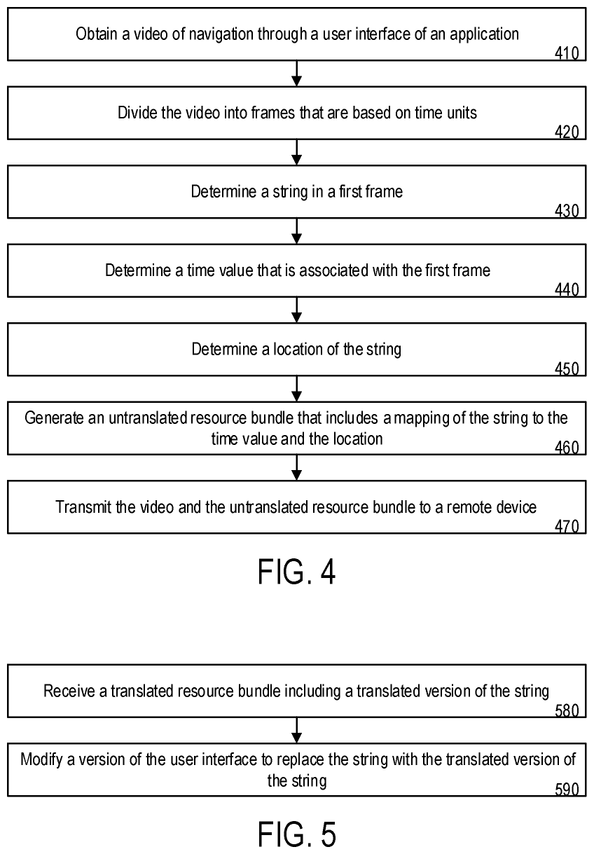

FIG. 4 is a flow chart of an example of a process for preparing the video of navigation through the UI for use as context in translating the UI in accordance with some embodiments of the present disclosure. FIG. 4 is described below in regards to the preparing device 210 in FIG. 2, but other implementations are possible.

In block 410, processor 212 obtains a video of navigation through a UI of an application. In some embodiments, processor 212 generates the video. In some examples, processor 212 detects a change in the UI of the application and captures a video recording of navigation through the UI of the application in response to detecting the change. In additional or alternative embodiments, processor 212 receives the video via the communication interface 218 from a video recording module.

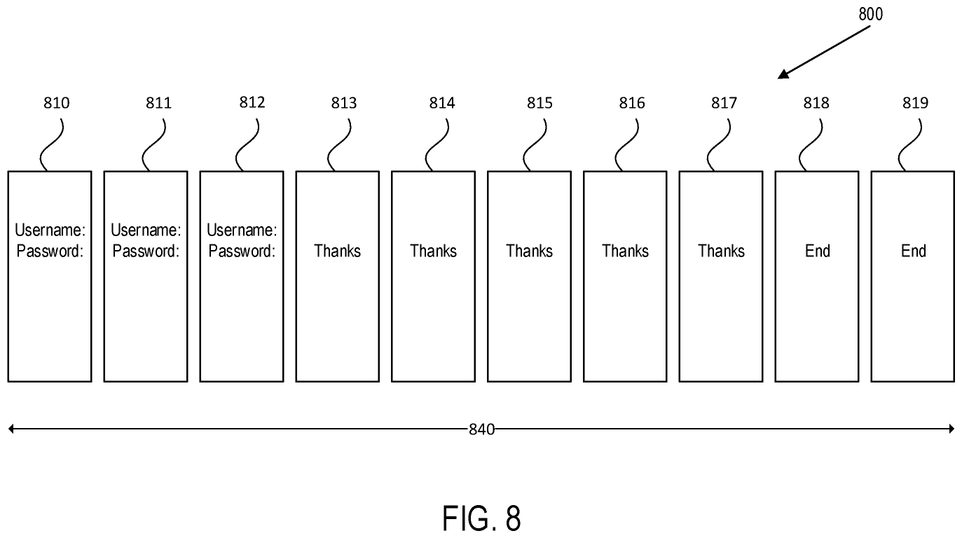

In block 420, processor 212 divides the video into frames that are based on time units. An example of a video divided into frames is described later in regards to FIG. 8. In some embodiments, the processor 212 may divide the video by sampling the video at multiples of the time unit. The time unit may be predetermined to provide a frame rate that will capture all translatable strings in the UI or may be determined by the processor 212 by analyzing the video to determine a frequency of changes in the UI. In additional or alternative embodiments, the processor 212 may receive the video in a pre-divided form. In some embodiments, each frame of the video includes translatable strings of text.

In block 430, processor 212 determines a string that is in a first frame of the video. In some examples, the processor 212 may perform optical character recognition to determine the string that is in the first frame. In additional or alternative examples, the processor 212 may compare the first frame to information associated with the UI to determine the string captured in the first frame. In some embodiments, processor 212 determines the string is in a set of frames of the video. The processor 212 can determine a different prior frame for each of the frames of the video that the string is in such that each of the different prior frames depict different contextual elements based on different paths having been navigated through the UI of the application to arrive at each frame of the set of frames.

In block 440, processor 212 determines a time value that is associated with the first frame. The time value may be known from dividing the video or may be included in meta data associated with the video. In block 450, processor 212 determines a location of the string within the first frame. The processor 212 can apply a coordinate system to the first frame and determine coordinates for the string relative to the coordinate system. In block 460, processor 212 generates an untranslated resource bundle that includes a mapping of the string to the time value and the location. The mapping can be stored as a separate file or as meta data for the video.

In block 470, processor 212 transmits, via communication interface 218, the video and the untranslated resource bundle to a remote device. In some embodiments, processor 212 packages the video and the untranslated resource bundle such that selection of the string from the untranslated resource bundle causes the video to display a visual effect at the location in the first frame. The visual effect can include modifying the string to stand out such as bolding the text in the string or changing the color of the text in the string. The visual effect can include modifying an area around the string such as highlighting or circling the location of the string.

In some embodiments, processor 212 packages the video and the untranslated resource bundle such that selection of the string from the untranslated resource bundle causes the video to start at a second frame of the video and end at the first frame. The second frame can be a frame of the video that is associated with a lower time value such that the displayed portion of the video provides more circumstantial context for the string. In some examples, the untranslated resource bundle includes an additional mapping to the second frame.

In some embodiments, processor 212 can package the video and the untranslated bundle such that the video includes selectable links for switching a displayed portion of the video between different frames associated with the string (e.g., frames that include the string and frames that come prior to a frame that includes the string).

In some embodiments, processor 212 determines each of the translatable strings in each of the frames of the video. In some examples, the processor 212 can detect one or more of the frames of the video are duplicate frames based on the duplicate frames including a same set of translatable strings as another frame in the video. The processor 212 can modify the video to remove the duplicate frames or reduce a resolution of duplicate frames to reduce the size of the video. The processor 212 can determine the time value associated with each of the frames that includes one of the translatable strings. The processor 212 can exclude the duplicate frames prior to determining the time values for the frames such that fewer processing resources are used. The processor 212 can determine the location associated with each of the translatable strings. The processor 212 can exclude the duplicate frames prior to determining the location for each of the translatable strings such that fewer processing resources are used. The processor 212 can package the video and the untranslated bundle to include a complete mapping of each of the translatable strings to the frame it is in and the location within the frame of the translatable string.

FIG. 5 is a flow chart of an example of a process for modifying a version of the UI in response to receiving a translation associated with the video in accordance with some embodiments of the present disclosure. FIG. 5 is described below in regards to the preparing device 210 in FIG. 2 and as following block 470 of FIG. 4, but other implementations are possible.

In block 580, processor 212 receives, via the communication interface 218, a translated resource bundle including a translated version of the string. The translated resource bundle can include a mapping of the translated version of the string to the string or to the frame and location within the frame of the string.

In block 590, processor 212 modifies a version of the UI to replace the string with the translated version of the string. In some embodiments, the translated resource bundle can be used to replace all instances of the string within a UI to the translated version of the string. In additional or alternative embodiments, the translated resource bundle can be used to determine a string within the UI that was captured at a specific location within a specific frame of the video and to replace the string with the translated version of the string. The translated resource bundle can include a complete mapping of translated versions of all the translatable strings in the UI such that a single translated resource bundle can be used to generate a fully translated UI.

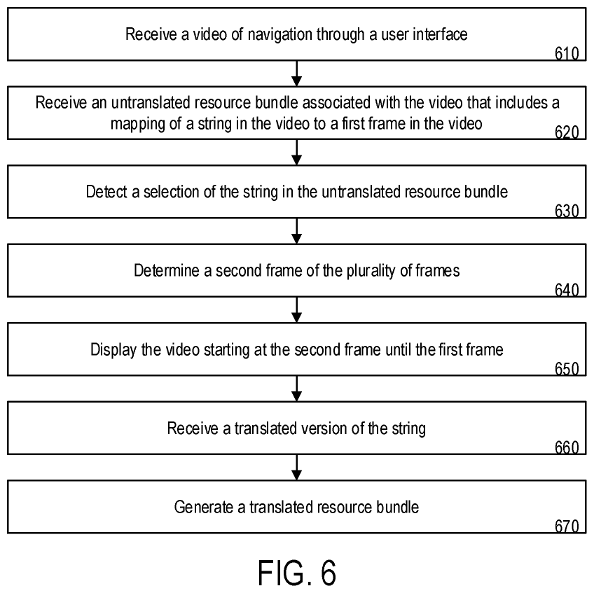

FIG. 6 is a flow chart of an example of a process for determining a translation of strings in the UI using the video of navigation through the UI in accordance with some embodiments of the present disclosure. FIG. 6 is described below in regards to the translating device 360 in FIG. 3, but other implementations are possible.

In block 610, processor 362 receives, via communication interface 368, a video of navigation through a UI. In block 620, processor 362 receives, via communication interface 368, an untranslated resource bundle associated with the video, the untranslated resource bundle including a mapping of a string in the video to a first frame in the video. In one example, processor 362 receives the video and the untranslated resource bundle from processor 312 in response to block 470 of FIG. 4.

In block 630, processor 362 detects a selection via the user communication interface 370 of the string in the untranslated resource bundle. In some examples, the processor 362 can display a list of translatable strings via the user communication interface 370. The processor 362 can detect selection of one of the translatable strings in the list in response to input from a mouse, keyboard, or other input device. In additional or alternative examples, access of the video or the untranslated resource bundle by a user can be detected as selection of one of the translatable strings.

In block 640, processor 362 determines a second frame of the plurality of frames. In some examples, the untranslated resource bundle can include a mapping of the string to the second frame and the processor 362 can determine the second frame from the untranslated resource bundle. In additional or alternative examples, the processor 362 can determine the second frame to be a frame in the video with a lower time value than the first frame. The second frame may be the immediately prior frame to the first frame or a prior non-duplicative frame.

In block 650, processor 362 displays via the user communication interface 370 the video starting at the second frame until the first frame. The processor 362 can display a visual effect at the location of the string in the first frame. The visual effect can include modification of the string or an area surrounding the string to draw the attention of the translator. For example, the visual effect can include changing the font color or style of the string. The processor 362 can also display a selectable link and responsive to detecting selection of the selectable link, jumping the video to the first frame.

In some embodiments, the untranslated resource bundle can include a mapping of the translatable string to more than one frame of the video in which the translatable string occurs. The corresponding frames may be non-duplicative and the processor 362 may display selectable links associated with each of the corresponding frames. In response to detecting selection of one of the selectable links, the processor 362 may display the respective corresponding frame or may start the video at a respective corresponding prior frame and stop at the respective corresponding frame.

In block 660, processor 362 receives via the user communication interface 370 a translated version of the string. In some examples, the translated version of the string is in response to displaying a portion of the video starting at the second frame until the first frame. The translated version of the string can be based on circumstantial context displayed in the portion of video.

In block 670, processor 362 generates a translated resource bundle. In some examples, the translated resource bundle is generated by mapping the translated version of the string to the location of the string. In additional or alternative examples, the translated resource bundle is generated by mapping the translated version of the string to the string.

In some embodiments, processor 362 transmits the translated resource bundle via communication interface 368 to a remote device. For example, processor 362 can transmit the translated resource bundle to processor 312, which is described receiving the translated resource bundle in block 580 of FIG. 5.

In additional or alternative embodiments, processor 362 can receive via the communication interface 368 the video and an untranslated resource bundle that includes a complete mapping of all translatable strings in the UI that were captured by the video to each of their locations. In some examples, the video has a reduced frame rate during portions of the video that include duplicate frames. The processor 362 can receive via the user communication interface 370 translated versions of each of the translatable strings. The processor 362 can generate a translated resource bundle that is based on each of the translatable strings.

### Example UI Translation System

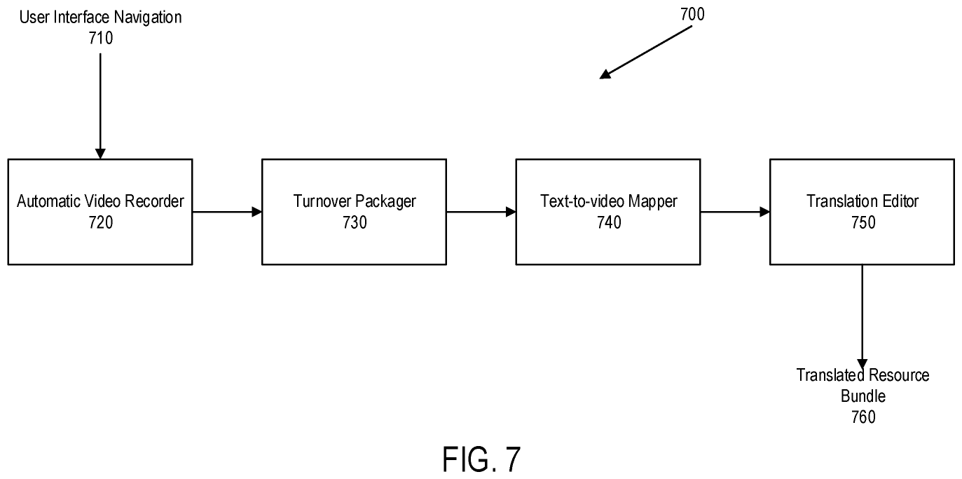

FIG. 7 is a block diagram of system 700 configured according to some embodiments of the present disclosure to translate strings in a UI using a video of navigation through the UI of an application. The system 700 can include an automatic video recorder 720, turnover packager 730, text-to-video mapper 740, and a translation editor 750.

The automatic video recorder 720 can detect a change in the UI and record UI navigation 710 to form a video. FIG. 8 is a block diagram of a video 800 that can be captured by the automatic video recorder 720. The video 800 has a length 840 and can be divided into ten frames 810-819. In this example, the length 840 of the video 800 can be 10 seconds and the time value used to divide the video 800 into frames 810-819 can be 1 second. Although automatic video recorder 720 can record various videos, this example will be described in regards to video 800. The automatic video recorder 720 can output the video 800.

The turnover packager 730 can receive the video 800 from the automatic video recorder 720. The turnover packager 730 can extract all the strings from the frames 810-819 and determine that frames 810-812 contain the same set of strings, frames 813-817 contain the same string, and frames 818-819 contain the same string. Therefore frames 811-812 can be considered duplicates of frame 810, frames 814-817 can be considered duplicates of frame 813, and frame 819 can be considered a duplicate of frame 818. In some examples, the duplicate frames 811-812, 814-817, 819 can be removed from the video or resolution for these frames can be reduced to reduce the size of the video. In additional or alternative examples, the duplicate frames 811-812, 814-817, 819 can be flagged as duplicates to prevent further processing associated with the duplicate frames 811-812, 814-817, 819. The turnover packager 730 can output the video 800 with modifications based on the duplicative frames 811-812, 814-817, 819.

The text-to-video mapper 740 can receive the video 800 from the turnover packager 730. The text-to-video mapper 740 can map each translatable string to a non-duplicative frame 810, 813, 818 and to a location within the non-duplicative frame 810, 813, 818. For example, “Username:” can be mapped to frame 810 and a specific location within frame 810. The location may include a coordinate and a dimension of the string within a frame. The text-to-video mapper 740 can output the video 800 and the untranslated resource bundle.

The translation editor 750 can receive the video 800 and the untranslated resource bundle from the text-to-mapper 740. The translation editor 750 can display portions of the video in response to selection of a translatable string by a translator. In this example, the translator can select “Thanks” from the untranslated bundle. The translation editor 750 can determine that the untranslated bundle maps “Thanks” to frame 813 and play the video 800 from frame 810 to frame 813. The translation editor 750 may start the video 800 at frame 810 by determining that frame 810 is the frame with the previous time value stored in the untranslated bundle. In additional or alternative examples, the translation editor 750 may start the video 800 at the beginning of the video to provide greater context to the translator or may start the video at frame 812 by determining that frame 812 is the immediately prior frame to frame 813.

In response to displaying the video 800, the translation editor 750 can receive a translated version of the string from the translator. The translation editor 750 can generate a translated resource bundle 760 based on the translated version of the string and the untranslated resource bundle. The translated resource bundle 760 can include a mapping of the translated version of the string to an associated frame and a location within the frame. The translation editor 750 and output the translated resource bundle 760 for use in generating a translated version of the UI.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method for preparing a video of navigation through a user interface of an application as context in translating the user interface, the method comprising:
obtaining, by a processing device, the video of navigation through the user interface of the application;
dividing, by the processing device, the video of the navigation through the user interface of the application into a plurality of frames that are based on time units, each frame of the plurality of frames including a plurality of strings comprising text;
determining, by the processing device, a string of the plurality of strings that is in a first frame of the plurality of frames;
determining, by the processing device, a time value that is associated with the first frame of the plurality of frames;
determining, by the processing device, a location of the string of the plurality of strings that is in the first frame of the plurality of frames;
generating, by the processing device, an untranslated resource bundle that includes a mapping of the string of the plurality of strings to the time value of the first frame of the plurality of frames and to the location of the string of the plurality of strings; and
transmitting, via a communication interface that is communicatively coupled to the processing device, the video of navigation through the user interface of the application and the untranslated resource bundle to a remote device.

2. The method of claim 1, further comprising:
receiving, via the communication interface, a translated resource bundle including a translated version of the string; and
modifying a version of the user interface to replace the string of the plurality of strings with the translated version of the string.

3. The method of claim 1, wherein transmitting the video and the untranslated resource bundle comprises packaging the video and the untranslated resource bundle such that the video displays a visual effect at the location of the string of the plurality of strings in response to selection of the string in the untranslated resource bundle.

4. The method of claim 1, wherein transmitting the video and the untranslated resource bundle comprises packaging the video and the untranslated resource bundle such that in response to the string being selected from the untranslated resource bundle, the video starts at a second frame of the plurality of frames, the second frame being associated with a lower time value than the time value, and wherein the video ends at the first frame.

5. The method of claim 1, wherein obtaining the video comprises:
detecting a change in the user interface of the application; and
capturing a video recording of the user interface of the application in response to detecting the change.

6. The method of claim 1, wherein determining the string of the plurality of strings comprises determining the string of the plurality of strings is in a set of frames of the plurality of frames, each frame of the set of frames having a different prior frame that depicts different contextual elements based on a different path having been navigated through the user interface of the application to arrive at each frame of the set of frames, and
wherein transmitting the video and the untranslated resource bundle comprises packaging the video and the untranslated resource bundle such that the video includes selectable links for switching a displayed portion of the video between each of the different associated prior frames.

7. The method of claim 1, wherein determining the string of the plurality of strings comprises determining the plurality of strings that are in the plurality of frames,
wherein determining the time value associated with the first frame comprises determining other time values that are each associated with another frame of the plurality of frames that include another string of the plurality of strings,
wherein determining the location comprises determining a plurality of location each location of the plurality of location being associated with another string of the plurality of strings within a frame of the plurality of frames, and
wherein generating the untranslated resource bundle comprises generating the untranslated resource bundle to include a complete mapping of each string of the plurality of strings to the time value associated with the frame that each string of the plurality of strings is in and the location of each string of the plurality of string within the frame.

8. The method of claim 7, further comprising:
in response to determining the plurality of strings, detecting duplicate frames within the plurality of frames based on the duplicate frames including a same set of strings as another frame in the plurality of frames; and
removing duplicate frames from the plurality of frames prior to determining the time value associated with each frame of the plurality of frames and prior to determining the location of each string of the plurality of string.

9. The method of claim 7, further comprising:
in response to determining the plurality of strings, detecting duplicate frames within the plurality of frames based on the duplicate frames including a same set of strings as another frame in the plurality of frames; and
modifying the video to have a reduced frame rate during a portion of the video that includes the duplicate frames.

10. The method of claim 7, further comprising:
in response to determining the plurality of strings, detecting duplicate frames within the plurality of frames based on the duplicate frames including a same set of strings as another frame in the plurality of frames; and
removing the duplicate frames from the video such that a size of the video is reduced.

11. A method for using a video of navigation through a user interface of an application as context in translating the user interface, the method comprising:
receiving the video of navigation through the user interface of the application, the video including a plurality of frames;
receiving an untranslated resource bundle associated with the video, the untranslated resource bundle including a mapping of a string in the video to a first frame of the plurality of frames and a location of the string within the first frame;
detecting a selection of the string in the untranslated resource bundle;
responsive to detecting the selection of the string, determining a second frame of the plurality of frames that is non-duplicative of the first frame and occurs before the first frame in the video;
displaying the video starting at the second frame until the first frame;
responsive to displaying the video, receiving a translated version of the string; and
generating a translated resource bundle based on the translated version of the string and the untranslated resource bundle.

12. The method of claim 11, wherein receiving the video comprises receiving the video from a remote device via a telecommunication network, the method further comprising transmitting the translated resource bundle to the remote device via the telecommunications network.

13. The method of claim 11, wherein displaying the video comprises:
displaying a visual effect at the location of the string in the video;
displaying a selectable link to the first frame; and
responsive to detecting the selectable link being selected, displaying the first frame.

14. The method of claim 11, wherein receiving the video and the untranslated resource bundle comprises receiving the mapping of the string to the second frame, wherein determining the second frame is based on the mapping.

15. The method of claim 14, wherein receiving the video and the untranslated resource bundle further comprises receiving the mapping of the string to a set of first frames that include the first frame, each first frame of the set of first frames having a different associated prior frame, the different associated prior frame for the first frame being the second frame, and
wherein displaying the video comprises:
displaying selectable links to each of the set of first frames and each of the different associated prior frames; and
responsive to detecting one of the selectable links being selected, displaying the corresponding frame of the set of first frames or the corresponding different associated prior frame.

16. The method of claim 11, wherein receiving the video and the untranslated resource bundle further comprises receiving the untranslated resource bundle including a complete mapping of a plurality of strings, including the string, to a plurality of locations, including the location, in the video,
wherein receiving the translated version of the string comprise receiving a translated version of each string in the plurality of strings, and
wherein generating the translated resource bundle is further based on the translated version of each string in the plurality of strings.

17. The method of claim 16,
wherein receiving the video comprises receiving the video having a reduced frame rate during portions of the video that includes duplicate frames.

18. The method of claim 11, wherein displaying the video starting at the second frame until the first frame comprises displaying context for the string, and wherein receiving the translated version of the string comprises receiving the translated version associated with the context.

19. The method of claim 11, wherein generating the translated resource bundle comprises mapping the translated version of the string to the location of the string.

20. A computer program product for preparing a video of navigation through a user interface of an application as context in translating the user interface, the computer program product comprising a non-transitory computer readable medium storing program code configured to be executed by a processor to perform operations comprising:
obtaining the video of navigation through the user interface of the application;
dividing the video of the navigation through the user interface of the application into a plurality of frames based on time units, each frame of the plurality of frames including a plurality of strings comprising text;
determining a string of the plurality of strings that is in a first frame of the plurality of frames;
determining a time value that is associated with the first frame of the plurality of frames;
determining a location of the string of the plurality of strings that is in the first frame of the plurality of frames;
generating an untranslated resource bundle that includes a mapping of the string of the plurality of strings to the time value of the first frame of the plurality of frames and to the location of the string of the plurality of strings; and
transmitting, through a communication interface that is communicatively coupled to the processor, the video and the untranslated resource bundle to a remote device.
